(19) United States
(12) Patent Application Publication
(10) Pub. No.: US 2016/0003307 A1
(43) Pub. Date: Jan. 7, 2016

(54) CLUTCH DISC

(71) Applicant: Schaeffler Technologies AG & Co. KG, Herzogenaurach (DE)

(72) Inventors: Friederike Grumer, Achern (DE); Christoph Raber, Ottweiler-Steinbach (DE); Gregor Galwas, Schwerte (DE); Stefan Steinmetz, Esslingen (DE)

(73) Assignee: Schaeffler Technologies AG & Co. KG, Herzogenaurach (DE)

(21) Appl. No.: 14/769,629

(22) PCT Filed: Feb. 19, 2014
(86) PCT No.: PCT/DE2014/200074

§ 371 Date: Aug. 21, 2015

(30) Foreign Application Priority Data
Feb. 21, 2013 (DE) 10 2013 202 862.8

(51) Int. Cl. F16D 13/64

(52) U.S. Cl. CPC F16D 13/648; F16D 13/64

(57) ABSTRACT

A clutch disc (1) for a wet running clutch, including a carrier device (4) and friction lining elements (6, 7, 22, 23). The carrier device (4) is designed as an annular body with recesses (11, 12, 24) for the friction lining elements.

### BACKGROUND

The invention relates to a clutch disc for a wet-running clutch, comprising a carrier device and friction lining elements.

From the German patent publication DE 10 2011 086 521 A1 a method is known for the production of a friction body, in which paper blanks are produced by a pulp molding process. From the international publication WO 2010/14265 A1 a method is known for the production of a friction lining for friction clutches in a motor vehicle.

### SUMMARY

The objective of the invention is to provide a clutch disc for a wet-running clutch with a carrier device and friction lining elements, which is designed in a simple fashion and can be produced cost-effectively.

The objective is attained in a clutch disc for a wet-running clutch, comprising a carrier device and friction lining elements, such that the carrier device is embodied as an annular body with recesses for the friction lining elements. The annular body can also be called a cage and serves to fix the friction lining elements in reference to each other. The friction lining elements can advantageously be embodied as pads, as used in synchronization devices. Synchronization devices with pads are described, for example, in the German patent publications DE 10 2010 053 947 A1 and DE 10 2006 061 414 A1. By the embodiment of the clutch disc according to the invention in a particularly advantageous embodiment the same friction elements or pads can be used as also utilized in synchronization elements. This way the production of the clutch disc can be considerably simplified. Furthermore, the use of the friction elements and the pads provides surprising technical advantages. This way, for example over the entire thickness of the part, a suspension and/or compressibility can be generated, not only over the thickness of the friction linings as common in prior art, which linings are connected in a material-to-material fashion to the carrier device.

A preferred exemplary embodiment of the clutch disc is characterized in that the annular body comprises a basic body, which exhibits the shape of a circular ring with recesses for the friction lining elements. The friction lining elements are fixed in the recesses of the basic body. The friction elements may for example be fixed in the recesses in a force-fitting and/or form-fitting fashion. Here, advantageously a material-to-material connection between the friction lining elements and the basic body can be waived.

Another preferred exemplary embodiment of the clutch disc is characterized in that the basic body exhibits an essentially rectangular cross-section for the ring. This yields the advantage that the basic body can be produced easily and cost-effectively.

Another preferred exemplary embodiment of the clutch disc is characterized in that entraining elements are provided at an angle pointing from the basic body radially inwardly or radially outwardly. The entraining elements are advantageously connected in one piece with the basic body and serve to generate a torque-proof connection to a carrier of lamellae. The entraining elements are angled inwardly in order to connect to a carrier of lamellae. In order to connect to a carrier with external lamellae the entraining elements are angled radially outwardly.

Another preferred exemplary embodiment of the clutch disc is characterized in that the basic body exhibits a lesser thickness than the friction lining elements. In clutch discs of prior art the friction lining elements are adhered to the carrier device. Thus, only the thickness of the lining elements is available to generate any suspension and/or compressibility. Here, the thickness of the lining elements available to generate the suspension and/or compressibility is reduced by the thickness of the carrier device. By the embodiment of the clutch disc according to the invention advantageously the complete thickness of the part can be used to form a suspension and/or compressibility of the clutch disc.

Another preferred exemplary embodiment of the clutch disc is characterized in that the basic body is created as a formed sheet metal. This way, the production of the clutch disc is further simplified. The basic body is advantageously embodied as a stamped part.

Another preferred exemplary embodiment of the clutch disc is characterized in that in the recesses the basic body has fixing projections for the friction lining elements. The fixing projections are embodied as fixing cams, for example, which engage the friction lining elements.

Another preferred exemplary embodiment of the clutch disc is characterized in that the basic body is formed multilayered like a sandwich. The basic body may comprise for example three formed metal sheets embodied as stamped parts.

Another preferred exemplary embodiment of the clutch disc is characterized in that a central basic body element exhibits larger recesses than the exterior basic body elements. The central basic body element guides the friction lining elements. The exterior basic body elements fix the friction lining elements in the axial direction. The term axial direction relates to the axis of rotation of the clutch disc. Here, axial represents in the direction or parallel to the axis of rotation of the clutch disc.

Another preferred exemplary embodiment of the clutch disc is characterized in that the clutch disc is embodied as a lamella of a wet-running multi-disc clutch. A multi-disc clutch represents a single clutch or a duplex clutch. It is particularly advantageous to use the clutch disc according to the invention in two-wheeler applications, particularly in motorcycles.

The invention further relates to a carrier device for a clutch disc described above. The carrier device can be commercially obtained separately.

### BRIEF DESCRIPTION OF THE DRAWINGS

Additional advantages, features, and details of the invention are discernible from the following description, in which various exemplary embodiments are described in detail with reference to the drawing. Shown are:

FIG. 1 a perspective and partially cross-sectioned illustration of a clutch disc according to the invention;

FIG. 2 an enlarged illustration of a detail of FIG. 1;

FIG. 3 a similar illustration as shown in FIG. 2 according to another exemplary embodiment; and

FIG. 4 a perspective illustration of a friction lining element.

### DETAILED DESCRIPTION OF THE PREFERRED EMBODIMENTS

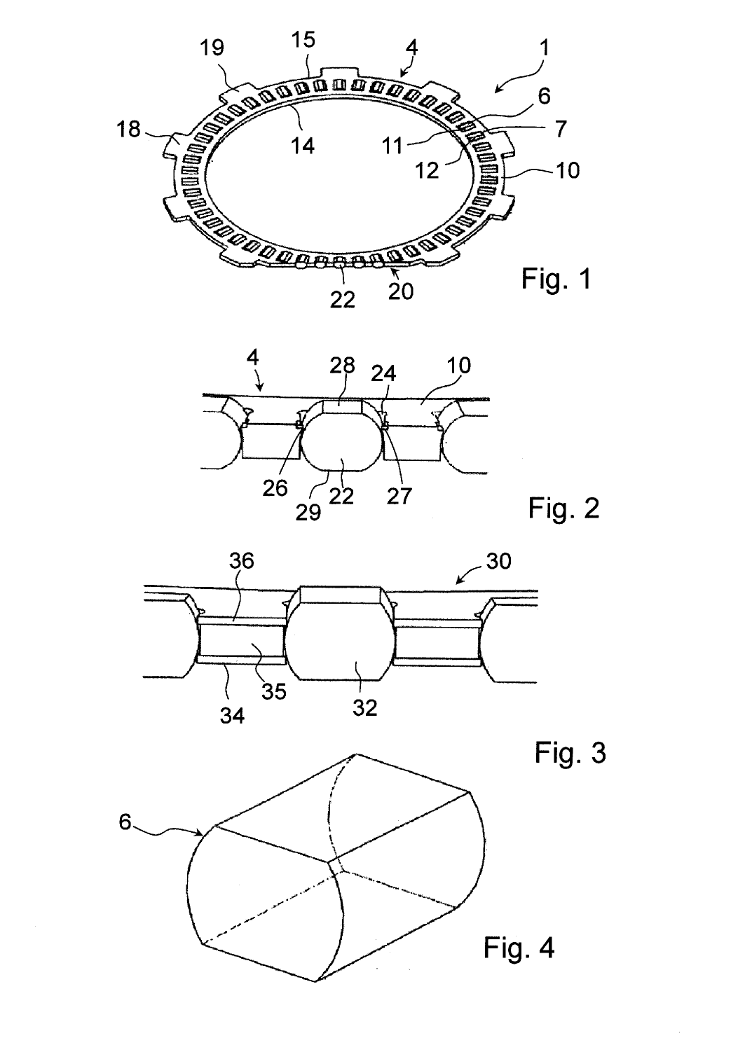

FIG. 1 shows a clutch disc 1 according to the invention in a perspective and partially cross-sectioned view. Here the invention can be used in all types of clutch discs. The clutch disc 1 according to the invention is however used in a particularly advantageous fashion in wet-running multi-disc clutches. The clutch disc 1 shown in FIG. 1 is embodied as a lamella of a wet-running multi-layered clutch in a lamella-based design.

The clutch disc 1 comprises a carrier device 4, which serves to fix a plurality of friction lining elements 6, 7. FIG. 4 shows the friction lining element 6 alone in a perspective view. The friction lining elements 6, 7 advantageously represent so-called pads, as described for example in the German patent publications DE 10 2006 061 414 A1 and DE 10 2010 053 947 A1.

The pads or friction elements or friction lining elements disclosed in the above-stated patent publications represent synchronization devices. According to an essential aspect of the invention the friction lining elements, friction elements, or pads known in the context with synchronization equipment are used in the clutch disc 1. By the use of the pads as the friction material the production costs for the clutch disc 1 can be reduced.

The carrier device 4 of the clutch disc 1 comprises a basic body 10 made from sheet metal. The sheet metal is produced, for example, from aluminum or steel. In order to fix the friction lining elements 6, 7 the basic body 10 exhibits a plurality of recesses 11, 12. Each of the friction lining elements 6, 7 is accepted in a recess 11, 12.

The basic body 10 exhibits the form of an annular disc with a rectangular cross-section. Radially inwardly the basic body 10 is limited by an internal diameter 14. Radially outwardly the basic body 10 is limited by an external diameter 15. Tongue-shaped entraining elements 18, 19 are provided at an angle, projecting from the external diameter 15 of the basic body 10.

FIG. 2 shows enlarged a cross-sectioned detail 20 of FIG. 1 in a perspective fashion. In the cross-section shown, it is discernible that a friction lining element 22, also shown in a cross-sectioned fashion, is fastened by fixing projections 26, 27 in a recess 24 of the basic body 10 of the carrier device 4.

The fixing projections 26, 27 are embodied and arranged such that the friction lining element 22 is held stably in the recess 24 of the basic body 10. At the top and the bottom two friction areas 28, 29 are embodied at the friction lining element 22. In the exemplary embodiment the friction areas 28, 29 are smaller than the corresponding recesses 24 in the basic body 10.

According to another aspect of the invention, the friction lining elements 22 may also have a different shape, in which the friction areas 28, 29 are larger than the respectively corresponding recess 24. Then the friction elements and/or friction lining elements 22 overlap the basic body 10 in the area of the recesses 24. For this purpose, the friction lining elements may be embodied like an umbrella.

FIG. 3 shows a basic body 30 with a friction lining element 32. Unlike the exemplary embodiment shown in FIG. 2, the basic body 30 is here embodied from several parts and/or in a multilayered fashion. The basic body 30 comprises three basic body elements 34, 35, 36, combined like a sandwich.

The basic body element 35 is arranged in a sandwich structure between the two external basic body elements 34 and 36. Here, the central basic body element 35 exhibits a considerably greater thickness than the two basic body elements 34 and 36. The central basic body element 35 is furthermore embodied with a slightly greater recess for the friction lining element 32.

Here, the central basic body element 35 serves to guide the friction lining element 32. The two external basic body elements 34 and 36 each have a smaller recess. The smaller recesses in the external basic body elements 34 and 36 serve to fix the friction lining elements 32 in the axial direction.

### LIST OF REFERENCE CHARACTERS

1 Clutch disc

4 Carrier device

6 Friction lining element

7 Friction lining element

10 Basic body

11 Recess

12 Recess

14 Internal diameter

15 External diameter

18 Entraining element

19 Entraining element

20 Cross-sectioned area

22 Friction lining element

24 Recess

26 Fixing projection

27 Fixing projection

28 Friction area

29 Friction area

30 Basic body

32 Friction lining element

34 Basic body element

35 Basic body element

36 Basic body element

1. A clutch disc for a wet-running clutch, comprising a carrier device and friction lining elements, the carrier device is embodied as an annular body with recesses for the friction lining elements.

2. The clutch disc according to claim 1, wherein the annular body comprises a basic body, in the form of a circular disc with the recesses for the friction lining elements.

3. The clutch disc according to claim 2, wherein the basic body has an essentially rectangular cross-section.

4. The clutch disc according to claim 2, wherein entraining elements are provided at an angle projecting from the basic body radially inwardly or radially outwardly.

5. The clutch disc according to claim 1, wherein the basic body has a smaller thickness than the friction lining elements.

6. The clutch disc according to claim 1, wherein the basic body is a formed sheet metal part.

7. The clutch disc according to claim 1, wherein the basic body has a multi-layered construction.

8. The clutch disc according to claim 7, wherein the basic body includes a central basic body element and external basic body elements located on opposing sides thereof, and the central basic body element has larger sized recesses than the external basic body elements.

9. The clutch disc according to claim 1, wherein the clutch disc is embodied as a lamella of a wet-running multi-disc clutch.

10. A carrier device for a clutch disc (1), comprising an annular body with recesses for friction lining elements, the annular body includes a basic body in the form of a circular disc with the recesses therein, with the basic body having a multi-layered construction.

11. The carrier device of claim 10, wherein the basic body includes a central basic body element and external basic body elements located on opposing sides thereof, and the central basic body element has larger sized recesses than the external basic body elements.
